(19) United States
(12) Patent Application Publication
(10) Pub. No.: US 2019/0075513 A1
(43) Pub. Date: Mar. 7, 2019

(54) Method for broadcasting a communication network identifier, method for connecting to a communication network, related computer program, hosting medium and mobile terminal

(71) Applicant: PARROT DRONES, Paris (FR)

(72) Inventors: Sébastien Gager, Paris (FR); Hugo Grostabussiat, Paris (FR); Clément Lassieur, Paris (FR); Thomas Barse, Saint Germain En Laye (FR)

(21) Appl. No.: 16/119,721

(22) Filed: Aug. 31, 2018

(30) Foreign Application Priority Data
Sep. 6, 2017 (FR) 17 58222

(51) Int. Cl. H04W 48/10; H04W 8/26; H04W 76/16; H04W 88/04

(52) U.S. Cl. CPC H04W 48/10; H04W 8/26; H04W 48/12; H04W 88/04; H04W 76/16

(57) ABSTRACT

The invention relates to a method for broadcasting a network identifier associated with a first protocol, the network comprising a mobile terminal and a removable accessory for a hosting medium, the accessory comprising a camera, a first data transceiver according to the first protocol, the broadcasting method being implemented by the hosting medium comprising a second on-board transceiver within the hosting medium, and capable of communicating according to a second communication protocol, the method comprising at least, once the accessory is connected to the hosting medium: the broadcasting of a message comprising an identifier of the hosting medium and representative of the connection of the accessory, the configuration and the broadcasting by the first transceiver of a network identifier (SSID) identical to the identifier of the hosting medium.

The present invention relates to a method for broadcasting a communication network identifier associated with a first wireless communication protocol, the network comprising at least a mobile communication terminal and a removable accessory for a hosting medium, such as a portable medium or a vehicle with no pilot on board, in particular a drone.

In particular, the drone is a rotary-wing drone, or a fixed-wing drone, in particular of the “sailwing” type. Hereinafter, a “drone” refers to an aircraft with no pilot on board. A drone is autonomous or piloted remotely, in particular using a control stick.

The invention also relates to a method for connecting to a communication network associated with a first wireless communication protocol, the communication network being of the aforementioned type.

The invention also relates to a computer program comprising software instructions which, when executed by a computer, implement the aforementioned method for broadcasting a communication network identifier and/or the aforementioned method for connecting to this communication network.

The invention also relates to a hosting medium, such as a portable medium or a vehicle with no pilot on board, in particular a drone, on which a removable accessory is able to be connected, then forming an electronic assembly comprising both the hosting medium and the removable accessory connected to the hosting medium.

The invention also relates to a mobile communication terminal able to belong to a communication network associated with a first wireless communication protocol, the communication network being of the aforementioned type.

The invention also relates to an electronic system comprising at least the hosting medium and the mobile terminal of the aforementioned type.

Portable and mobile hosting media are known for accessories in particular corresponding to a camera, such as drones able to be piloted remotely, in particular using a control stick according to a wireless communication protocol.

For example, for miniaturization purposes and in order to limit the energy consumption of the control and the drone, the used wireless communication protocol limits the energy consumption necessary to produce the communication stream between the control stick and the drone and for example corresponds to a small to medium range communication protocol such as the NFC (Near Field Communication) protocol, or more particularly the BLE (Bluetooth Low Energy) protocol, also known as “Bluetooth Smart®”.

However, this type of drone piloted using such wireless protocols with low energy consumption is not suitable for the real-time communication of a video stream requiring a higher communication throughput.

Thus, this type of drone currently does not allow that application to the capture and broadcasting of images in real time, which limits the user's experience and simply prevents immersive piloting of such drones.

One aim of the invention is then to propose a solution for enhancing the immersive experience of the user while optimizing the energy consumption and the associated volume of the hosting medium as well as the control stick remotely controlling the hosting medium.

To that end, the invention relates to a method for broadcasting a communication network identifier associated with a first wireless communication protocol, the network comprising at least a mobile communication terminal and a removable accessory for a hosting medium, such as a portable medium or a vehicle with no pilot on board, in particular a drone, the accessory comprising at least a camera, a first data transceiver according to the first communication protocol, and a connector configured for the electrical connection of the accessory to a connection port of the hosting medium,

the broadcasting method being implemented by the hosting medium comprising a second on-board transceiver within the hosting medium, the second transceiver being capable of communicating according to a second communication protocol separate from the first communication protocol, the method comprising at least, once the accessory is electrically connected to the hosting medium:
the broadcasting, by the second transceiver, of a message comprising at least one identifier of the hosting medium, the message further being representative of the connection of the accessory to the hosting medium,
the configuration and broadcasting of a network identifier able to be sent by the first transceiver of the removable accessory, the network identifier being identical to the identifier of the hosting medium.

According to other advantageous aspects of the invention, the method for broadcasting a communication network identifier is such that the first communication protocol corresponds to Wi-Fi and wherein the second communication protocol corresponds to Bluetooth Low Energy.

The invention also relates to a method for connecting to a communication network associated with a first wireless communication protocol, the network comprising at least a mobile terminal and a removable accessory for a hosting medium, such as a portable medium or a vehicle with no pilot on board, in particular a drone, the accessory comprising at least a camera, a first data transceiver according to the first communication protocol, and a connector configured for the electrical connection of the accessory to a connection port of the hosting medium,

the broadcasting method being implemented by the hosting medium comprising a second on-board transceiver within the hosting medium, the second transceiver being capable of communicating according to a second communication protocol separate from the first communication protocol,
the connection method being implemented by the mobile terminal and successively comprising:
the reception, according to the second communication protocol, of a message sent by the second transceiver of the hosting medium, the message comprising an identifier of the hosting medium, the message further being representative of the connection of the accessory to the hosting medium,
the reception of usage selection information of the hosting medium entered by a user, and
the automatic connection of the mobile terminal to the communication network associated with the first wireless communication protocol, the communication network being identified by the mobile terminal using a network identifier corresponding to the identifier of the hosting medium.

The invention also relates to a computer program comprising software instructions which, when executed by a computer, implement at least one of the methods as defined above.

The invention also relates to a hosting medium, such as a portable medium or a vehicle with no pilot on board, in particular a drone, on which a removable accessory is able to be connected, the accessory comprising at least one camera, a first data transceiver according to the first communication protocol, and a connector configured for the electrical connection of the accessory to a connection port of the hosting medium, the hosting medium comprising:
a second transceiver on board within the hosting medium, the second transceiver being capable of:
   communicating according to a second communication protocol separate from the first communication protocol,
   broadcasting a message, once the accessory is electrically connected to the hosting medium, the message comprising an identifier of the hosting medium, the message further being representative of the connection of the accessory to the hosting medium,
a module for configuring a network identifier capable of being sent by the first transceiver of the removable accessory, the network identifier being identical to the identifier of the hosting medium, the communication network being associated with the first wireless communication protocol and comprising at least one mobile terminal and a removable accessory for a hosting medium.

According to other advantageous aspects of the invention, the hosting medium comprises one or more of the following features, considered alone or according to all technically possible combinations:
the connection port of the hosting medium is a USB port dedicated at least to the connection of said accessory;
the movement of the hosting medium is able to be piloted by:
   a control stick using piloting instructions sent according to the second communication protocol independently of the connection of the accessory to the hosting medium, or
   the mobile terminal using piloting instructions sent according to the first communication protocol, in the presence of the removable accessory comprising the camera connected to the hosting medium, or using piloting instructions sent according to the second communication protocol, in the absence of the removable accessory comprising the camera connected to the hosting medium;
the first transceiver of the removable accessory connected to the hosting medium is capable of sending a video stream captured by said camera according to the first communication protocol to said mobile terminal once connected to said communication network;
the hosting medium is configured to transmit, according to the first communication protocol, via the first transceiver, at least one piece of head-up retrieval information capable of being superimposed in real-time on said video stream displayed via said mobile terminal.

The invention also relates to a mobile communication terminal capable of belonging to a communication network associated with a first wireless communication protocol, the communication network comprising at least the mobile terminal and a removable accessory for a hosting medium, such as a portable medium or a vehicle with no pilot on board, in particular a drone, the accessory comprising at least a camera, a first data transceiver according to the first communication protocol, and a connector configured for the electrical connection of the accessory to a connection port of the hosting medium,

the broadcasting method being implemented by the hosting medium comprising a second on-board transceiver within the hosting medium, the second transceiver being capable of communicating according to a second communication protocol separate from the first communication protocol,

the mobile terminal comprising:
a first transceiver module according to the second communication protocol, of a message sent by the second transceiver of the hosting medium, the message comprising an identifier of the hosting medium, the message further being representative of the connection of the accessory to the hosting medium,
a module for receiving usage selection information of the hosting medium entered by a user, and
a module for the automatic connection of the mobile terminal to the communication network associated with the first wireless communication protocol, the communication network being identified by the mobile terminal using a network identifier corresponding to the identifier of the hosting medium.

According to other advantageous aspects of the invention, the mobile terminal comprises one or more of the following features, considered alone or according to all technically possible combinations:
the mobile terminal is configured to be able to be inserted into an immersive viewing system capable of being worn by a user;
the mobile terminal, once connected automatically to said communication network associated with the first communication protocol, is configured to:
   receive, via a second transceiver module, and retrieve a video stream received according to the first communication protocol, and
   in case of interruption of the connection to the communication network associated with the first communication protocol in the process of retrieving the video stream, display the last image received prior to said interruption during a predetermined period.

The invention also relates to an electronic system comprising at least the hosting medium and the mobile terminal of the aforementioned type, the electronic system being capable of implementing both the aforementioned method for broadcasting a communication network identifier and the aforementioned method for connecting to a communication network.

These features and advantages of the invention will appear more clearly upon reading the following description, provided solely as a non-limiting example, and done in reference to the appended drawings, in which:

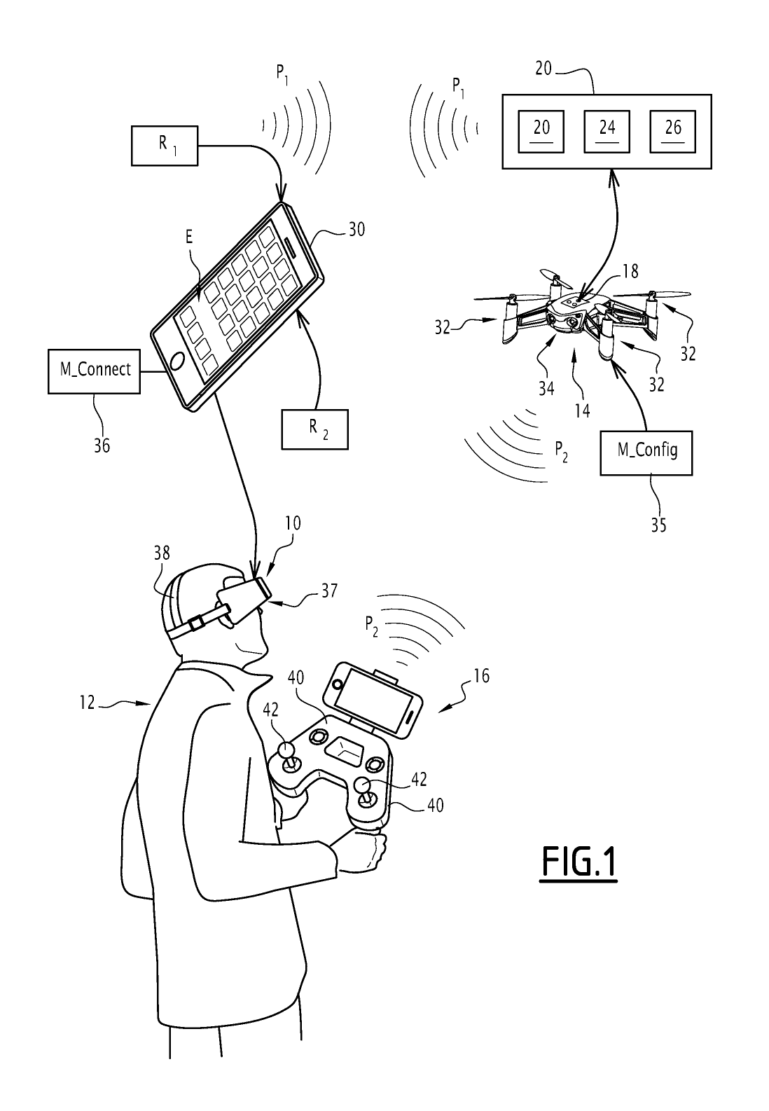

FIG. 1 is a perspective view of an electronic system for piloting a hosting medium for a removable video capture camera according to the invention, comprising a drone, moving through the air under the control of remote control equipment;

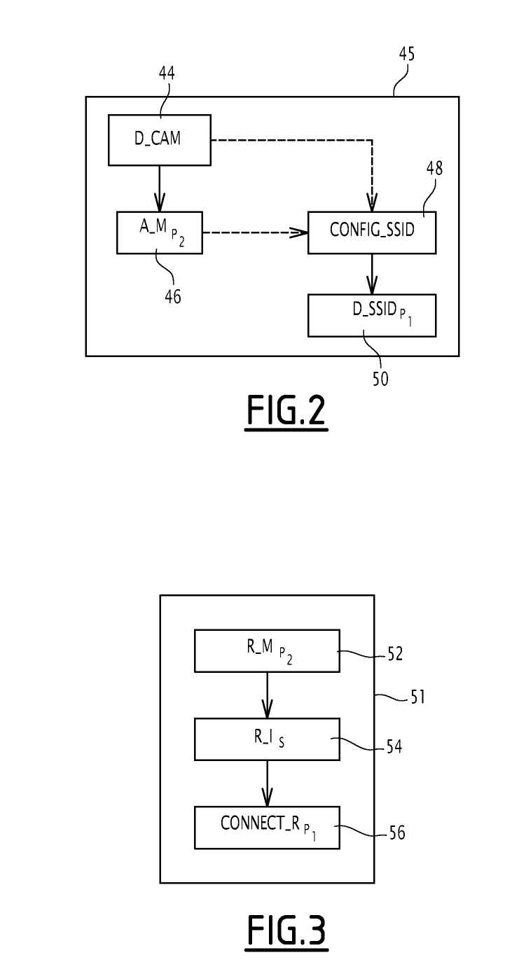

FIG. 2 is a flowchart of a method for broadcasting a communication network identifier according to the invention;

FIG. 3 is a flowchart of a method for connecting to a communication network according to the invention;

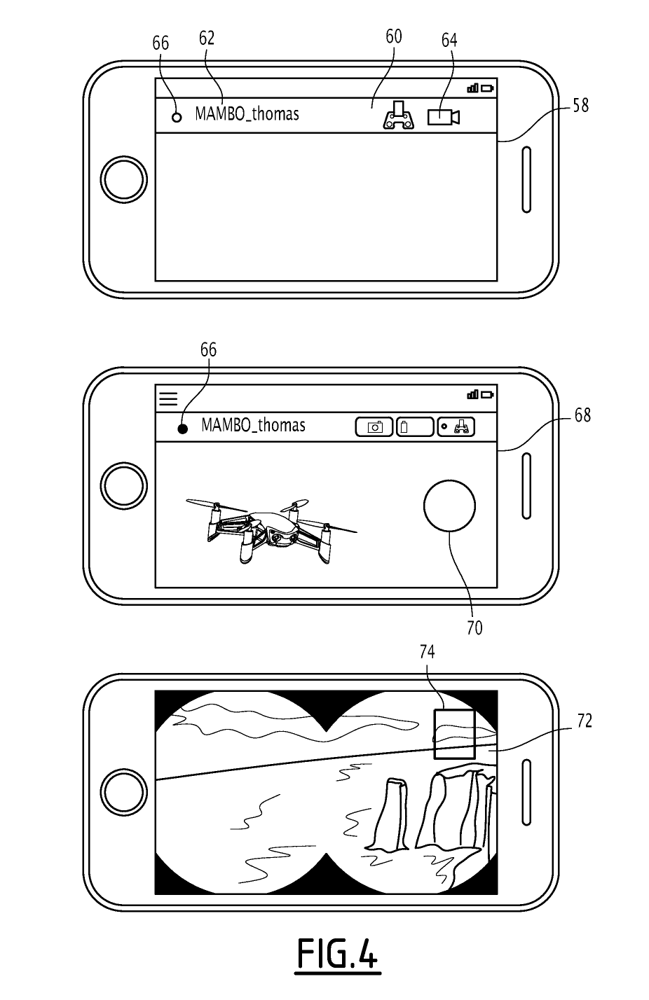

FIG. 4 illustrates three examples of successive displays obtained on the mobile terminal according to the present invention;

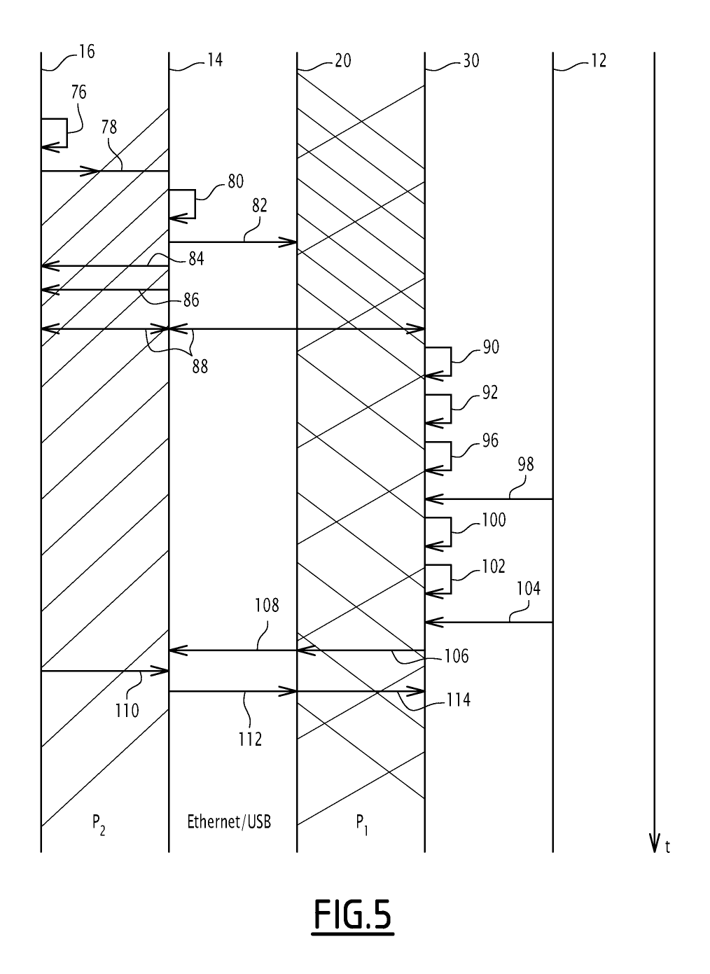

FIG. 5 is a sequential diagram representative of communication exchanges within the system according to the present invention.

In the rest of the description, the expression “substantially equal to” refers to an equality relationship to within plus or minus 10%, i.e., with a variation of no more than 10%, also preferably to an equality relationship to within plus or minus 5%, i.e., with a variation of no more than 5%.

In FIG. 1, an electronic system for piloting a hosting medium for a removable camera makes it possible, using the electronic viewing system 10, for a user 12 to optimize the guiding of a hosting medium corresponding to a drone 14 and to collect a video stream obtained using an accessory, comprising the camera, and connected to the drone 14. Once connected to the drone 14, the removable accessory comprising the camera forms, with the drone 14, a mobile image capture electronic assembly.

The drone 14 is a motorized flying vehicle able to be piloted remotely, in particular via a joystick 16 allowing the user 12 to enter his flight commands.

The drone 14, i.e., an aircraft with no pilot on board, comprises a connection port 18 for a removable accessory 20 comprising at least one camera 22, a first data transceiver 24 according to a first communication protocol P1, in particular corresponding to Wi-Fi, and the connector 26 configured for the electrical connection of the accessory to the connection port 18 of the drone 14, for example a USB (Universal Serial Bus) port.

The camera 22 comprises a lens associated with an image sensor, not shown, configured to acquire an image of a scene comprising a plurality of objects.

The first data transceiver 24 of the removable accessory 20 is in particular capable of transmitting, in real time, the data associated with the video stream captured in real time by the camera 22 to a mobile terminal 30 capable of being inserted into the viewing system 10.

To that end, the first transceiver 24 for example comprises a video stack, a server, not shown, according to the RTCP (Real-time Transport Control Protocol) network protocol based on periodic transmissions of controlled data packets, and a data diffuser according to the RTP (Real-time Transport Protocol) computer communication protocol. A video stack of the first transceiver 24 is able to deliver a video stream to a routing module according to the Internet Protocol (IP) capable of routing the video stream toward the Wi-Fi antenna, not shown, of the first transceiver 24, such that the antenna emits a video stream, in the form of data packets according to the UDP (User Datagram Protocol) and RTP protocols, intended for the first Wi-Fi transceiver module R₁ of the mobile terminal 30 capable of: sending RTCP messages in return, receiving and retrieving on a display screen E of the mobile terminal 30.

Furthermore, according to one particular aspect, the first transceiver 24 of the drone 14 is configured to transmit, according to the first communication protocol P₁, at least one piece of head-up retrieval information I_HUD capable of being superimposed in real-time on said video stream displayed via said mobile terminal 30 in the viewing system 10.

Furthermore, the first Wi-Fi transceiver module R₁ of the mobile terminal 30, once the connection is made with the first transceiver 24 of the removable accessory 20 comprising the camera 22 and connected to the drone 14, which supplies electricity to the first transceiver 24, is also capable, in return, of sending video adjustment commands to the drone 14 in order for example to control the throughput of the video stream, the image quality, the beginning/end of the broadcasting/recording of the video stream, a change in Wi-Fi channel when several other drone users are present, the initiation of an anti-flickering mode, etc. These video adjustment commands sent by the mobile terminal 30 are capable of passing through the first transceiver 24 of the removable accessory 20, then through the connector 26 of the removable accessory 20 connected to the connection port 18 of the drone 14, recovering these commands after passing in a software module of the drone 14, not shown, capable of converting this data into the form of packets according to the Ethernet protocol.

The drone 14 is for example a rotary-wing drone, comprising at least one rotor 32 (or propeller) actuated by at least one motor. In FIG. 1, the drone 14 comprises a plurality of rotors 32, and is then called multi-rotor drone. The number of rotors 32 is in particular equal to four in this example, and the drone 14 is then a quadrirotor drone or quadcopter.

According to one particular alternative, the drone 14 is of the “mini-drone” type, and has dimensions of 15×15 cm to 20×20 cm, in particular 18×18 cm for the MAMBO® model in the Applicant's name.

According to other alternatives, the invention is applicable to any other type of drone with a size larger than a mini-drone, whether the drone is of the rotary-wing or fixed-wing type, for example of the “sailwing” type.

The drone 14 is also provided with a second transceiver 34 for exchanging piloting data or data associated with other removable accessories separate from the removable accessory 20 comprising the camera 22, for example a removable grabber or a cannon, preferably by radio waves according to a second communication protocol P2, in particular corresponding to the BLE (Bluetooth Low Energy) type, also known under the name “Bluetooth Smart®”, intended for a piece of electronic equipment, such as the second receiving module R₂ of the mobile terminal 30, of the electronic viewing system 10, or the receiving module, not shown, of the control stick 16.

More specifically, according to the invention, the second transceiver 34 is capable of:
communicating according to the second communication protocol P₂, separate from the first communication protocol P₁, with the second receiving module R₂ of the mobile terminal 30 and/or with the receiving module, not shown, of the control stick 16;
broadcasting a message M, once the accessory 20 is electrically connected to the hosting medium 14, the message M comprising an identifier ID of the hosting medium 14, for example MAMBO_thomas (corresponding to the MAMBO® drone by the user 12 with first name Thomas), the message further being representative of the connection of the accessory 20 to the hosting medium 14.

Furthermore, the drone 14 is also provided with a module 35 for configuring an SSID (Service Set Identifier) network identifier capable of being sent by the first transceiver 24 of the removable accessory 20, the SSID network identifier being identical to the identifier of the MAMBO-thomas drone 14, the communication network being associated with the first wireless communication protocol and comprising at least one mobile terminal and a removable accessory for a hosting medium.

Reciprocally, the second receiving module R₂ of the mobile terminal 30 is capable of receiving, according to the second communication protocol P₂, the message M sent by the second transceiver 34 of the drone 14, the message M comprising the identifier ID of the drone 14, the message further being representative of the connection of the accessory to the hosting medium.

Furthermore, the mobile terminal 30 comprises a receiving module, not shown, for usage selection information of the drone 14 on which the accessory 20 comprising the camera 22 is connected, the information being entered by a user 12, via an entry interface, for example the touch-sensitive screen E of the mobile terminal 30.

The terminal 30 also comprises a module 36 for the automatic connection of the mobile terminal 30 to the communication network associated with the first wireless communication protocol P₁, i.e., the Wi-Fi protocol, the communication network being identified by the mobile terminal 30 using a network identifier corresponding to the identifier of the hosting medium corresponding to the drone 14.

In other words, once the use of the drone 14 connected to the accessory 20 comprising the camera 22 is activated by the user 12, the terminal 30 is only capable of communicating with the drone 14 according to the first communication protocol P₁ and is no longer capable of communicating with the drone 14 with the second communication protocol P₂ previously used, in particular to receive the message M.

Furthermore, according to one particular aspect, in case of interruption of the connection of the mobile terminal 30 to the communication network associated with the first communication protocol P₁ in the process of retrieving the video stream, the mobile terminal 30 is capable of displaying, during the predetermined period, the last image received prior to said interruption. This aspect in particular allows the user 12 to approach the location of the drone 14 at the time of the interruption, the last retrieved image being representative of this location, the interruption optionally being due to an impact or accident of the drone 14 having led to the disconnection of the removable accessory 20 from the connection port 18 of the drone causing a break in the power supply of the first transceiver 24 of this accessory 20.

According to the example shown in FIG. 1, an electronic viewing system 10 allows the user 12 to view images, in particular images of the video received from the rotary wing drone 14 via the first protocol P1 when the removable accessory 20 is connected to the drone 14, thus making it possible to power the first Wi-Fi transceiver 24.

The electronic viewing system 10 comprises the mobile terminal 30, for example a smartphone, provided with a display screen, and a headset 37 comprising a reception support of the mobile terminal 30, a bearing surface against the face of the user 12, across from the user's eyes, and two optical devices positioned between the reception support and the bearing surface.

The headset further comprises a maintaining strap 38 making it possible to maintain the headset 37 on the head of the user 12.

The mobile terminal 30 is removable with respect to the headset 37 or integrated into the headset 37. For example, before beginning the broadcasting of the stream in immersive mode (i.e., when the mobile terminal 30 is in the headset 37, and the drone 14 is piloted via the control stick 16), the mobile terminal 30 is outside the headset 37 and capable of being used manually by the user 12, in particular to send the aforementioned video adjustment information via a mobile video stream retrieval software application stored within the mobile terminal 30.

The electronic viewing system 10 is for example connected to the joystick 16 via a data link, not shown, the data link being a wireless link or a wired link.

The viewing system 10 is for example a virtual-reality viewing system, i.e., a system allowing the user 12 to view an image in his field of view, with a field of view (or field of vision, FOV) angle with a large value, typically greater than 90°, preferably greater than or equal to 100°, in order to procure an immersive view (also called “FPV”, First Person View) for the user 12.

Such a viewing system 10 is optional and in particular makes it possible to enhance the “user experience” in the immersive piloting configuration, piloting, via the mobile terminal 30, without using this viewing system 10 or the control stick 16 also being possible.

The joystick 16 is known in itself, and for example makes it possible to pilot the rotary wing drone 14. The control stick 16 comprises two gripping handles 40, each being intended to be grasped by a respective hand of the user 12, a plurality of control members, here comprising two joysticks 42, each being positioned near a respective gripping handle 40 and being intended to be actuated by the user 12, preferably by a respective thumb.

The control stick 16 also comprises a radio antenna, not shown, and a radio transceiver, not shown, for exchanging data by radio waves, via the second BLE protocol P₂ with the rotary-wing drone 14, both uplink and downlink. In other words, the control stick 16 is also able to broadcast messages according to the second BLE protocol P₂, such messages sent by the control stick comprising at least one identifier of the control stick 16.

Additionally, or alternatively in light of the viewing system 10, the mobile terminal 30 is mounted on the control stick 16 to assist the user 12 during the piloting of the drone 14.

The control stick 16 is configured to send the commands from the user to an automatic pilot electronic apparatus (i.e., automatic aid for manual piloting by the user), not shown, integrated into the drone 14, according to the second BLE protocol P₂.

In other words, the drone 14 is capable of being piloted by the control stick 16 using piloting instructions transmitted according to the second communication protocol P₂, i.e., the BLE protocol, independently of the connection of the accessory 20 to the drone 14, or by the mobile terminal 30 using piloting instructions transmitted according to the first communication protocol P₁, i.e., the Wi-Fi protocol, in the presence of the removable accessory comprising the camera 22 connected to the hosting medium, the hosting medium and the removable accessory that is connected thereto then forming an electronic assembly, or by the mobile terminal 30 using piloting instructions transmitted according to the second communication protocol P₂, i.e., the BLE protocol, in the absence of the removable accessory 20 comprising the camera 22 connected to the drone 14.

It will be noted that, although these diagrams are shown in the form of interconnected circuits, the implementation of the various functions is, according to one embodiment, essentially software-based, this depiction being provided purely as an illustration.

According to another embodiment, the invention is capable of being implemented using one or several programmable logic circuit(s), such as an FPGA (Field Programmable Gate Array), or in the form of a dedicated integrated circuit, such as an ASIC (Application Specific Integrated Circuit) mounted on an electronic board on board the rotary wing drone 14.

The operation of the electronic system, comprising at least the hosting medium corresponding to the aforementioned drone 14 and mobile terminal 30, will now be described using FIG. 2, illustrating a flowchart of the method 45 for broadcasting a communication network identifier implemented by the drone 14, FIG. 3 illustrating a flowchart of the method 51 for connecting to the communication network implemented by the mobile terminal 30, and FIG. 4 illustrating three examples of successive displays obtained on the mobile terminal 30 according to the present invention.

In FIG. 3, the method 45 for broadcasting a communication network identifier implemented by the drone 14 comprises a first step 44 for detecting the connection of the removable accessory 20 comprising the camera 22 to the drone 14 by detecting the connection of the connector 26 of the removable accessory 14 to the USB connection port 18 of the drone 14.

Such an assembly of the accessory 20 to the drone 14 in particular makes it possible to supply electricity to the Wi-Fi transceiver 24 of the accessory 20 via the battery, not shown, of the drone 14.

According to a step 46, the second transceiver 34 of the drone 14 broadcasts, according to the second BLE communication protocol P2, a message M comprising at least one drone 14 identifier, for example MAMBO_thomas (corresponding to the MAMBO® drone of the user 12 with first name Thomas), the message further being representative of the connection of the accessory 20 comprising the camera 22 to the drone 14.

Such a message M is able to be broadcast (or BLE advertised) widely via the BLE protocol, i.e., to one or several mobile terminals 30 at once.

Then, or in parallel, the method 45 for broadcasting a communication network identifier comprises a step 48 for configuring a SSID network identifier capable of being sent by the first transceiver 24 of the removable accessory 20 connected to the drone 14, the SSID network identifier being identical to the identifier of the hosting medium corresponding to the drone 14, i.e., for example MAMBO_thomas.

In other words, the SSID identifier of the Wi-Fi network capable of being sent by the first transceiver 24 is imposed by the drone 14, such that it is identical to the identifier of the drone 14. This reconfiguration 48 in particular allows the user 12 to use any removable accessory 20, transparently, provided with a camera 22 (irrespective of whether this accessory belongs to the user 12 or is for example loaned by another user of another drone separate from the drone 14), the SSID associated with the transceiver 24 of this accessory automatically (i.e., without human intervention by the user 12) being reconfigured so as to be identical to the identifier associated with the drone 14.

Then, according to a step 50, the identifier of the MAMBO_thomas Wi-Fi network is broadcast by the first transceiver 24 of the removable accessory 20 connected to the drone 14.

In FIG. 3, the method 51 for connecting to the communication network implemented reciprocally by the mobile terminal 30 comprises a first step 52 for receiving, via the BLE transceiver module R₂ according to the second communication protocol P₂, the message M sent by the second BLE transceiver 34 of the drone 14, the message M comprising the MAMBO_thomas identifier of the hosting medium 14, the message M further being representative of the connection of the accessory 20 to the hosting medium 14.

Such a message M for example corresponds, on the mobile terminal 30 display 58, shown in FIG. 4, to the strip 60 simultaneously comprising the drone 14 identifier 62, for example MAMBO_thomas, an icon 64 representative of the presence of the camera 22 connected to the drone and a selection indicator 66.

Then, according to a step 54, the mobile terminal 30 implements a step 54 for receiving selection information I_{S} for usage of the drone 14 entered by the user 12, via an entry interface of the mobile terminal 30 for example corresponding to the touch-sensitive screen E. Indeed, due to the wide broadcasting implemented by the drone 14, the mobile terminal 30 is capable of potentially “seeing” several drones at once and retrieving a list of messages sent according to the BLE protocol P₂ by each of these drones, respectively. The selection implemented by the user 12 for example consists of digitally selecting, on the touch-sensitive screen E, the band 60 of the drone 14 connected with a camera 22 that he wishes to select.

Such a selection for example amounts to changing the display of the mobile terminal by triggering a change of color or texture of the selection indicator 66, as illustrated in the example displays 58 and 68 of FIG. 4.

Once the selection information 54 is received, the method 51 for connection to the communication network comprises a step 56 for the automatic connection of the mobile terminal 30 to the communication network associated with the first wireless Wi-Fi communication protocol P₁, the communication network being identified by the mobile terminal 30 using the SSID MAMBO_thomas network identifier corresponding to the MAMBO_thomas identifier of the hosting medium 14.

In other words, according to the inventive connection method 51, no intervention by the user 12 is necessary to view the list of available Wi-Fi networks, then select the relevant Wi-Fi network for the exchange of the video stream with the camera 22 of the accessory 20 connected to the drone 14.

Thus, a gain in time and a reduction in the usage complexity of the piloting in video retrieval mode is obtained according to the present invention. Indeed, according to the automatic connection step, the connection module 36 of the mobile terminal 30 automatically determines, once the selection of the drone 14 is made by the user, that the Wi-Fi network to be used will have the same identifier as that of the drone 14.

Once connected to the Wi-Fi network of the transceiver 24 of the removable accessory 20, the mobile terminal 30 is able to launch a software application dedicated to retrieving a video stream, the interface of which is shown on the display 68 of FIG. 4, such a software application for example being able to be activated manually by the user 12 using a touch-sensitive zone 70 of the display screen E.

Once the software application is activated, the user 12 places the mobile terminal 30 in the headset 37 and the retrieval of the video stream begins in immersive mode, as shown on the display 72 of FIG. 4.

During the real-time retrieval of the video stream via the Wi-Fi protocol, the drone 14 optionally sends, via the transceiver 24 of the removable accessory 20 comprising the camera 22, one or several pieces of head-up retrieval information I_HUD capable of being superimposed, in real time, in a dedicated zone 74, on the video stream displayed via the mobile terminal 30.

For example, the head-up retrieval information I_HUD informs the user of the battery level, the presence of a recording medium for the video stream within the drone 14, for example an SD (Secure Digital) card, the movement speed of the drone, its altitude, its attitude, its heading, the quality of the connection of the Wi-Fi network between the drone 14 and the mobile terminal 30, etc.

The exchanges within the electronic system of FIG. 1 comprise the control stick 16, the drone 14, the removable accessory 20 connected to the drone and comprising the camera 22 as well as the Wi-Fi transceiver 24 and the mobile terminal 30 and the interactions with the user 12 are now described with the sequential diagram of FIG. 5, showing these different exchanges over time t.

According to the first step 76, the control stick 16 is powered on. According to a step 78, the control stick 16 informs the surrounding electronic devices of its availability by broadcasting a message according to the communication protocol P2, i.e., the BLE, the message being known as “BLE advertisement”, the message further comprising an identifier of the control stick 16.

In parallel or successively, as shown in FIG. 5, the drone 14 is powered on according to a step 80. According to a step 82, the drone 14 detects the connection of the removable accessory 20 and configures this accessory 20, and more particularly the Wi-Fi transceiver 24 that it contains, in particular by configuring the SSID network identifier, or even the password to access this network. According to the invention, the SSID network identifier is identical to the identifier of the hosting medium corresponding to the drone 14. The accessory 20 comprising the camera applies these parameters imposed by the drone 14 and continues to wait for a connection of a surrounding electronic device to the Wi-Fi network associated with the Wi-Fi transceiver 24 of the accessory 20.

Then, according to a step 84, the drone 14 also informs the surrounding electronic devices of its availability by broadcasting a message according to the communication protocol P₂, i.e., the BLE, the message being known as “BLE advertisement”. According to a step 86, the drone 14 connects to the available control stick 16.

According to a step 88, the drone 14 indicates its status within a “BLE advertisement” message broadcast via the first communication protocol P₂.

Such a message then for example comprises the identifier of the drone, the type of removable accessory that is connected thereto (for example, a removable grabber or a cannon or the removable accessory 20 comprising the camera 22). Furthermore, the drone 14 directly transmits telemetry data to the camera, such as attitude angle, heading, battery level, altitude data, this data constituting head-up retrieval information I_HUD capable of being superimposed on the images from the video stream when it is retrieved.

Successively or in parallel, a software application of the mobile terminal 30 dedicated to the communication with the drone 14 and the retrieval of a video stream is launched according to a step 90. Once this software application is launched on the mobile terminal 30, the mobile terminal looks, according to a step 92, for all of the available devices within its range according to the communication protocol P₂, i.e., the BLE, and according to a step 96, displays, for example in the form of a list, all of the electronic devices within range.

According to a step 98, the user 12 selects, via an entry interface of the mobile terminal 30, for example a touch-sensitive screen, the electronic device he wishes to use from among the list of displayed electronic devices.

Then, according to a step 100, upon reception of the selection entered by the user, the mobile terminal 30 connects automatically to the Wi-Fi network associated with the transceiver 24 of the removable accessory 20 of the selected drone 14, with no additional interaction with the user 12 due to the fact that according to the invention, the mobile terminal 30 automatically “knows” that the selection of a drone 14, connected to a removable accessory 20 comprising a camera 22 and Wi-Fi transceiver 24, of the user is equivalent to a request and validation of the connection to the network associated with the Wi-Fi transceiver 24, the network being identified by the SSID identifier identical to the identifier of the drone 14.

Once connected to the Wi-Fi network, according to a step 102, the mobile terminal 30 retrieves a homepage 68 of the retrieval interface of a video stream as shown in FIG. 4, and the retrieval of the video stream in real time is triggered manually by the user 12 according to a step 104, for example by manual pressure on the zone 70 of the touch-sensitive screen E of the mobile terminal, as shown in FIG. 5.

Furthermore, during this step 104, the user 12 has the opportunity to select video adjustment commands in order for example to control the throughput of the video stream, the image quality, the beginning/end of the broadcasting/recording of the video stream, a change in Wi-Fi channel when several other drone users are present, the initiation of an anti-flickering mode, etc. These video adjustment commands are sent by the mobile terminal 30 according to a step 106, then are capable, according to a step 108, of passing through the first transceiver 24 of the removable accessory 20, then through the connector 26 of the removable accessory 20 connected to the USB connection port 18 of the drone 14, recovering these commands after passing in a software module of the drone 14, not shown, capable of converting this data into the form of packets according to the Ethernet protocol.

According to a step 110, once the videos adjustments are made within the drone 14, the control stick 16 sends piloting instructions according to the BLE communication protocol P₂ to the drone 14, which in turn, according to a step 112, transmits control instructions to the camera. Lastly, the camera 22 of the removable accessory 20 transmits, via the transceiver 24 and according to the Wi-Fi communication protocol P₁ suitable for the throughput of a video stream, the video stream to the mobile terminal 30 according to a step 114, the terminal retrieving, in particular when it is inserted into the headset 27, in an immersive vision, the video stream for the user 12.

Thus, the user 12 has a communication protocol P₁, for example Wi-Fi, suitable for retrieving a video stream, this protocol only being used by the mobile terminal 30 to communicate with the drone 14 in the presence of a removable accessory 20, comprising a camera 22 and the transceiver 24 according to the Wi-Fi communication protocol P₁, connected to the drone 14, the connection of the mobile terminal 30 to the communication network according to the Wi-Fi communication protocol P₁ being triggered by the prior broadcasting (or advertising) of a message M according to a second communication protocol P₂, for example BLE, separate from the Wi-Fi communication protocol P₁.

1. A method for broadcasting a communication network identifier associated with a first wireless communication protocol, the network comprising at least a mobile communication terminal and a removable accessory for a hosting medium, such as a portable medium or a vehicle with no pilot on board, the accessory comprising at least a camera, a first data transceiver according to the first communication protocol, and a connector configured for the electrical connection of the accessory to a connection port of the hosting medium,
the hosting medium comprising a second on-board transceiver within the hosting medium, the second transceiver being capable of communicating according to a second communication protocol separate from the first communication protocol, the method comprising at least, once the accessory is electrically connected to the hosting medium:
the broadcasting, by the second transceiver of the hosting medium, of a message comprising at least one identifier of the hosting medium, the message further being representative of the connection of the accessory to the hosting medium,
the configuration by the hosting medium of a network identifier, and the broadcasting by the first transceiver of the removable accessory, the network identifier being identical to the identifier of the hosting medium.

2. The broadcasting method according to claim 1, wherein the first communication protocol corresponds to Wi-Fi and wherein the second communication protocol corresponds to Bluetooth Low Energy.

3. A method for connecting to a communication network associated with a first wireless communication protocol, the network comprising at least a mobile terminal and a removable accessory for a hosting medium, such as a portable medium or a vehicle with no pilot on board, the accessory comprising at least a camera, a first data transceiver according to the first communication protocol, and a connector configured for the electrical connection of the accessory to a connection port of the hosting medium,
the hosting medium comprising a second on-board transceiver within the hosting medium, the second transceiver being capable of communicating according to a second communication protocol separate from the first communication protocol,
the method being implemented by the mobile terminal and successively comprising:
the reception, according to the second communication protocol, of a message sent by the second transceiver of the hosting medium, the message comprising an identifier of the hosting medium, the message further being representative of the connection of the accessory to the hosting medium,
the reception of usage selection information of the hosting medium entered by a user, and
the automatic connection of the mobile terminal to the communication network associated with the first wireless communication protocol, the communication network being identified by the mobile terminal using a network identifier corresponding to the identifier of the hosting medium.

4. A computer program product comprising software instructions for implementing a method according to claim 1.

5. A hosting medium, such as a portable medium or a vehicle with no pilot on board, on which a removable accessory is able to be connected, the accessory comprising at least a camera, a first data transceiver according to the first communication protocol, and a connector configured for the electrical connection of the accessory to a connection port of the hosting medium,
the hosting medium comprising:
a second transceiver on board within the hosting medium, the second transceiver being capable of:
communicating according to a second communication protocol separate from the first communication protocol,
broadcasting a message, once the accessory is electrically connected to the hosting medium, the message comprising an identifier of the hosting medium, the message further being representative of the connection of the accessory to the hosting medium,
a module for configuring a network identifier capable of being sent by the first transceiver of the removable accessory, the network identifier being identical to the identifier of the hosting medium, the communication network being associated with the first wireless communication protocol and comprising at least one mobile terminal and a removable accessory for a hosting medium.

6. The hosting medium according to claim 5, wherein the connection port of the hosting medium is a USB port dedicated at least to the connection of said accessory.

7. The hosting medium according to claim 5, wherein the movement of the hosting medium is capable of being piloted by:
a control stick using piloting instructions sent according to the second communication protocol independently of the connection of the accessory to the hosting medium, or
the mobile terminal using piloting instructions sent according to the first communication protocol, in the presence of the removable accessory comprising the camera connected to the hosting medium, or using piloting instructions sent according to the second communication protocol, in the absence of the removable accessory comprising the camera connected to the hosting medium.

8. The hosting medium according to claim 5, wherein the first transceiver of the removable accessory connected to the hosting medium is capable of sending a video stream captured by said camera according to the first communication protocol to said mobile terminal once connected to said communication network.

9. The hosting medium according to claim 8, wherein the hosting medium is configured to transmit, according to the first communication protocol, via the first transceiver, at least one piece of head-up retrieval information capable of being superimposed in real-time on said video stream displayed via said mobile terminal.

10. A mobile communication terminal capable of belonging to a communication network associated with a first wireless communication protocol, the communication network comprising at least the mobile terminal and a removable accessory for a hosting medium, such as a portable medium or a vehicle with no pilot on board, the accessory comprising at least a camera, a first data transceiver according to the first communication protocol, and a connector configured for the electrical connection of the accessory to a connection port of the hosting medium,
the hosting medium comprising a second on-board transceiver within the hosting medium, the second transceiver being capable of communicating according to a second communication protocol separate from the first communication protocol,
the mobile terminal comprising:
a first transceiver module according to the second communication protocol, of a message sent by the second transceiver of the hosting medium, the message comprising an identifier of the hosting medium, the message further being representative of the connection of the accessory to the hosting medium,
a module for receiving usage selection information of the hosting medium entered by a user, and
an automatic connection module of the mobile terminal to the communication network associated with the first wireless communication protocol, the communication network being identified by the mobile terminal using a network identifier corresponding to the identifier of the hosting medium.

11. The mobile communication terminal according to claim 10, wherein the mobile terminal is configured to be able to be inserted into an immersive viewing system capable of being worn by a user.

12. The mobile communication terminal according to claim 10, wherein the mobile terminal, once connected automatically to said communication network associated with the first communication protocol, is configured to:
receive, via a second transceiver module, and retrieve a video stream received according to the first communication protocol, and
in case of interruption of the connection to the communication network associated with the first communication protocol in the process of retrieving the video stream, display the last image received prior to said interruption during a predetermined period.

13. A computer program product comprising software instructions for implementing a method according to claim 3.
